(19) United States
(12) Patent Application Publication
(10) Pub. No.: US 2025/0182410 A1
(43) Pub. Date: Jun. 5, 2025

(54) METHODS, APPARATUSES AND COMPUTER PROGRAM PRODUCTS FOR FACILITATING ACTIONS BASED ON TEXT CAPTURED BY HEAD MOUNTED DEVICES

(71) Applicant: META PLATFORMS, INC., Menlo Park, CA (US)

(72) Inventors: Shengxin Zha, Ames, IA (US); Roshan Rajesh Sumbaly, Sunnyvale, CA (US); Jonathan Tan, Sunnyvale, CA (US)

(21) Appl. No.: 18/529,827

(22) Filed: Dec. 5, 2023

(51) Int. Cl. G06T 19/00; G02B 27/01; G06F 3/01; G06F 40/40; G06T 7/11; G06T 7/194; G06V 10/25; G06V 30/10; G06V 40/10

(52) U.S. Cl. CPC G06T 19/006; G02B 27/017; G06F 3/011; G06F 40/40; G06T 7/11; G06T 7/194; G06V 10/25; G06V 30/10; G06V 40/107; G02B 2027/0178

(57) ABSTRACT

A system and method for determining interesting text to trigger actions of devices are provided. The system may include one or more head-mounted devices associated with a network. A head mounted device(s) may capture an image(s) and/or a video(s) corresponding to an environment detected in a field of view of a camera(s). The image(s) and/or the video(s) may include one or more text items associated with the environment. The head mounted device may determine whether a text item(s) of the one or more text items is interesting. The head mounted device may extract the text item(s) determined as being interesting and may superimpose the text item(s) at a position in the image(s) and/or the video(s). The head mounted device may trigger, based on the text item(s) determined as being interesting, one or more actions capable of being performed by the head mounted device.

### TECHNOLOGICAL FIELD

Exemplary embodiments of this disclosure may relate generally to methods, apparatuses and computer program products for facilitating actions based on text captured in a field of view of smart glasses and/or augmented/virtual reality devices or the like.

### BACKGROUND

While there are currently various smart glasses, there is generally a lack of mechanisms for existing smart glasses to capture text found in the real world (e.g., billboards, product labels, etc.) and utilize the captured text as a trigger for performing certain follow-up actions by the smart glasses.

As such, it may be beneficial to provide an efficient and reliable mechanism for utilizing the text captured, by smart glasses, from one or more images and/or videos to facilitate actions to be performed by the smart glasses.

### BRIEF SUMMARY

Some examples of the present disclosure relate to triggering actions based on text captured in a field of view of smart glasses and/or augmented/virtual reality devices (e.g., a head-mounted display (HMD)). In this regard, examples of the present disclosure may enable smart glasses and/or augmented/virtual reality devices to facilitate capture of one or images and/or one or more videos associated with a field of view of a real world environment. The smart glasses and/or augmented/virtual reality devices may analyze one or more text items in the captured images and/or videos to determine interesting text. The determined interesting text may be utilized by the smart glasses and/or augmented/virtual reality devices to initiate/trigger one or more actions or functions to be performed by the smart glasses and/or augmented/virtual reality devices.

Some examples of actions based on captured text, may include but are not limited to, copying text, pasting text, extracting a phone number(s), extracting a website(s), extracting an email address(es), adding one or more contacts to a contact list, translating captured text in a language to another language associated with smart glasses and/or augmented/virtual reality devices (e.g., an image(s) of a subway billboard capturing text in Mandarin may be translated to English based on the English language being designated as a default language associated with smart glasses and/or augmented/virtual reality devices). Other suitable actions may also be performed based on text extracted from one or more images and/or one or more videos captured by smart glasses and/or augmented/virtual reality devices.

The examples of the present disclosure may provide smart intent understanding and perform follow-up actions based on captured text associated with one or more images and/or one or more videos corresponding to the real-world environment in the field of view of a camera associated with smart glasses and/or augmented/virtual reality devices.

The examples of the present disclosure may also facilitate selection of text items, from captured images and/or videos, to focus on and in some examples may crop (also referred to herein as smart crop) out data (e.g., background areas/regions) of the captured images and/or videos and may focus on an area determined to be an area of focus.

In one example of the present disclosure, a method is provided. The method may include capturing, via a head mounted device, at least one image or at least one video corresponding to an environment detected in a field of view of at least one camera. The at least one image or the at least one video may comprise one or more text items associated with the environment. The method may further include determining whether at least one text item of the one or more text items is interesting. The method may further include extracting the at least one text item determined as being interesting and superimposing the at least one text item at a position in the at least one image or the at least one video. The method may further include triggering, based on the at least one text item determined as being interesting, one or more actions capable of being performed by the head mounted device.

In another example of the present disclosure, an apparatus is provided. The apparatus may include one or more processors and a memory including computer program code instructions. The memory and computer program code instructions are configured to, with at least one of the processors, cause the apparatus to at least perform operations including capturing, via the apparatus, at least one image or at least one video corresponding to an environment detected in a field of view of at least one camera. The at least one image or the at least one video may comprise one or more text items associated with the environment. The memory and computer program code are also configured to, with the processor(s), cause the apparatus to determine whether at least one text item of the one or more text items is interesting. The memory and computer program code are also configured to, with the processor(s), cause the apparatus to extract the at least one text item determined as being interesting and superimposing the at least one text item at a position in the at least one image or the at least one video. The memory and computer program code are also configured to, with the processor(s), cause the apparatus to trigger, based on the at least one text item determined as being interesting, one or more actions capable of being performed by the apparatus.

In yet another example of the present disclosure, a computer program product is provided. The computer program product may include at least one non-transitory computer-readable medium including computer-executable program code instructions stored therein. The computer-executable program code instructions may include program code instructions configured to capture, via a head mounted device, at least one image or at least one video corresponding to an environment detected in a field of view of at least one camera. The at least one image or the at least one video may comprise one or more text items associated with the environment. The computer program product may further include program code instructions configured to determine whether at least one text item of the one or more text items is interesting. The computer program product may further include program code instructions configured to extract the at least one text item determined as being interesting and superimposing the at least one text item at a position in the at least one image or the at least one video. The computer program product may further include program code instructions configured to trigger, based on the at least one text item determined as being interesting, one or more actions capable of being performed by the head mounted device.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 is a diagram of an exemplary network environment in accordance with an example of the present disclosure.

FIG. 2 illustrates a diagram of an exemplary artificial reality system in accordance with an example of the present disclosure.

FIG. 3 illustrates a diagram of exemplary electromyography devices in accordance with an example of the present disclosure.

FIG. 4 is a diagram of an exemplary communication device in accordance with an example of the present disclosure.

FIG. 5 is a diagram of an exemplary computing system in accordance with an example of the present disclosure.

FIG. 6A and FIG. 6B are diagrams illustrating that an HMD determined that a first captured image and a second captured image includes a type of object such as, for example, a poster.

FIG. 7 is a diagram illustrating that an HMD captured an image and determined that the captured image includes text determined as being interesting text in accordance with an example of the present disclosure.

FIG. 8 is another diagram illustrating that an HMD captured an image and determined that the captured image includes text determined as being interesting text in accordance with an example of the present disclosure.

FIG. 9 is a diagram illustrating translated text based on text captured in a field of view of an HMD being presented superimposed over text of a real-world environment in accordance with an example of the present disclosure.

FIG. 10A and FIG. 10B are diagrams illustrating smart crop features in accordance with examples of the present disclosure.

FIG. 11A and FIG. 11B are diagrams illustrating smart crop features in accordance with other examples of the present disclosure.

FIG. 12 illustrates an example flowchart illustrating operations for determining interesting text to trigger actions of devices in accordance with an example of the present disclosure.

FIG. 13 illustrates an example of a machine learning framework in accordance with one or more examples of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of Augmented/Virtual/Mixed Reality.

As referred to herein, a social media handle(s) may be a public username and/or a private username associated with social media profiles/accounts that may be utilized to access information associated with a user(s) within a social media network(s).

As referred to herein, superimpose, superimposing, superimposition or the like, may refer to placement or positioning of an object(s), image(s), or video(s) on top of an existing image(s) and/or video(s) to augment an effect of the existing image(s) and/or video(s).

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Architecture

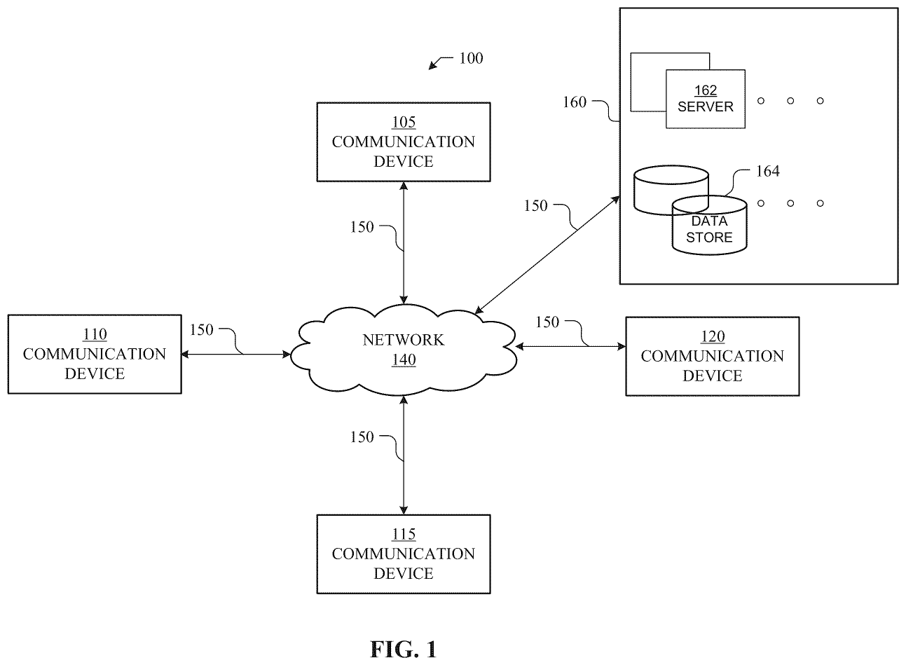

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. In some examples, the network 140 may be a Metaverse network. In other examples, the network 140 may be any suitable network capable of provisioning content and/or facilitating communications among entities within, or associated with the network. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or to allow users to interact with these entities through an application programming interfaces (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

### Exemplary Artificial Reality System

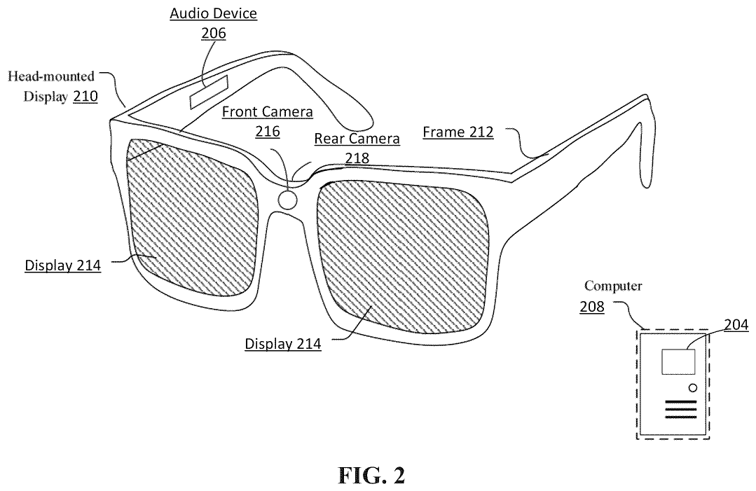

FIG. 2 illustrates an example artificial reality system 200. The artificial reality system 200 may include a head-mounted display (HMD) 210 (e.g., smart glasses and/or augmented/virtual reality device) comprising a frame 212, one or more displays 214, a computing device 208 (also referred to herein as computer 208) and a controller 204. In some examples, the HMD 210 may capture one or more items of text from one or more images/videos associated with a real world environment in the field of view of one or more cameras (e.g., cameras 216, 218) of the artificial reality system 200. The HMD 210 may utilize the captured text from the one or more images/videos to trigger one or more actions/functions by the artificial reality system 200. The displays 214 may be transparent or translucent allowing a user wearing the HMD 210 to look through the displays 214 to see the real world (e.g., real world environment) and displaying visual artificial reality content to the user at the same time. The HMD 210 may include an audio device 206 (e.g., speakers/microphones) that may provide audio artificial reality content to users. The HMD 210 may include one or more cameras 216, 218 which may capture images and/or videos of environments. In one exemplary embodiment, the HMD 210 may include a camera(s) 218 which may be a rear-facing camera tracking movement and/or gaze of a user's eyes.

One of the cameras 216 may be a forward-facing camera capturing images and/or videos of the environment that a user wearing the HMD 210 may view. The camera(s) 216 may also be referred to herein as a front camera(s) 216. The HMD 210 may include an eye tracking system to track the vergence movement of the user wearing the HMD 210. In one exemplary embodiment, the camera(s) 218 may be the eye tracking system. In some exemplary embodiments, the camera(s) 218 may be one camera configured to view at least one eye of a user to capture a glint image(s) (e.g., and/or glint signals). The camera(s) 218 may also be referred to herein as a rear camera(s) 218. The HMD 210 may include a microphone of the audio device 206 to capture voice input from the user. The artificial reality system 200 may further include a controller 204 comprising a trackpad and one or more buttons. The controller 204 may receive inputs from users and relay the inputs to the computing device 208. The controller 204 may also provide haptic feedback to one or more users. The computing device 208 may be connected to the HMD 210 and the controller 204 through cables or wireless connections. The computing device 208 may control the HMD 210 and the controller 204 to provide the augmented reality content to and receive inputs from one or more users. In some example embodiments, the controller 204 may be a standalone controller or integrated within the HMD 210. The computing device 208 may be a standalone host computer device, an on-board computer device integrated with the HMD 210, a mobile device, or any other hardware platform capable of providing artificial reality content to and receiving inputs from users. In some exemplary embodiments, the HMD 210 may include an artificial reality system/virtual reality system.

### Exemplary Electromyography Device

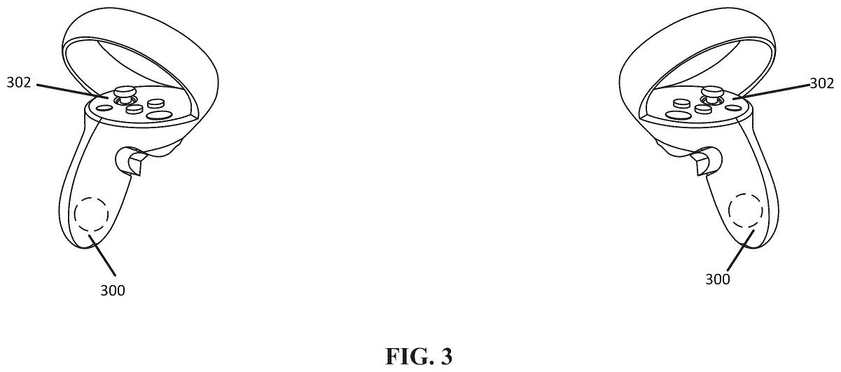

FIG. 3 illustrates an example diagram of electromyography (EMG) devices 300 in accordance with an example of the present disclosure. The EMG devices 300 may also be referred to herein as EMG sensors 300. The EMG devices 300 may communicate, and may be connected, with the artificial reality system 200. In some examples, the EMG devices 300 may communicate with the artificial reality system 200 via a near field communication (NFC), a radio frequency (RF) communication, a Bluetooth communication, a peer-to-peer communication, an Ultrawide Band (UWB) communication and/or the like. In this regard, in some examples the EMG devices 300 may communicate with the artificial reality system 200 in an instance in which the EMG devices 300 are within a proximity (e.g., a predetermined distance (e.g., up to 22 meters, up to 10 meters, up to 4 centimeters (cm), etc.)) of the artificial reality system 200.

The EMG devices 300 may detect one or more gestures and/or one or more selections or depressions of one or more buttons 302 of the EMG devices 300 configured to cause triggering of one or more actions by the artificial reality system 200. In some examples, the gestures may be one or more hand(s) movements, finger(s) movements and/or the like. The gestures may be predefined gestures in some examples. Additionally, in some examples, the gestures may be performed, and/or the one or more buttons 302 selected or depressed by a user wearing (e.g., around a wrist of the user) the EMG devices 300, in response to the HMD 210 of the artificial reality system 200 detecting a capture of one or more text items from a captured image(s) and/or video(s). The captured image(s) and/or video(s) may correspond to a real world environment in the field of view of a camera(s) (e.g., front camera(s) 216) of the HMD 210. The detection of one or more of the gestures and/or the selection(s) or depression(s) of one or more buttons 302 in response to the HMD 210 detecting one or more items of text associated with a captured image(s) or video(s) may trigger the HMD 210 to perform one or more actions/functions, as described more fully below.

### Exemplary Communication Device

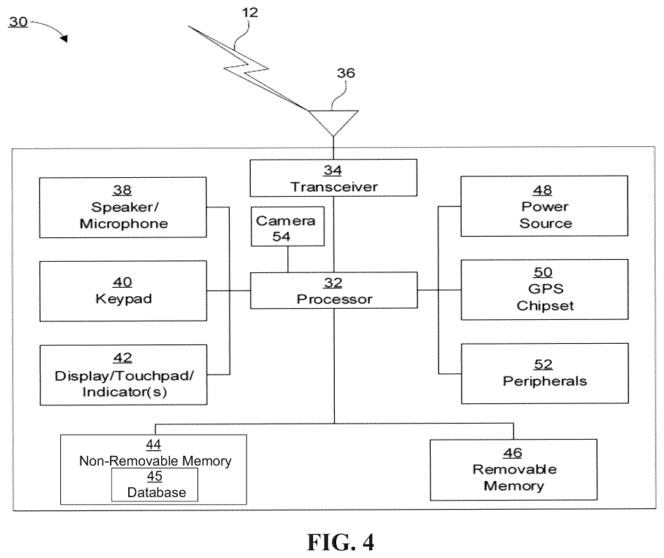

FIG. 4 illustrates a block diagram of an exemplary hardware/software architecture of a communication device such as, for example, user equipment (UE) 30. In some exemplary embodiments, the UE 30 may be any of communication devices 105, 110, 115, 120. In some exemplary embodiments, the UE 30 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device (e.g., artificial reality system 200), smart watch, charging case, or any other suitable electronic device. As shown in FIG. 4, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The power source 48 may be capable of receiving electric power for supplying electric power to the UE 30. For example, the power source 48 may include an alternating current to direct current (AC-to-DC) converter allowing the power source 48 to be connected/plugged to an AC electrical receptable and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The non-removable memory 44 may include a database 45. In some examples, the database 45 may store captured text items captured from one or more images and/or one or more captured videos. The captured images and/or videos may be captured by a camera (e.g., camera 54, front camera 216). In other examples, the database 45 may store any suitable data, content and/or the like. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

### Exemplary Computing System

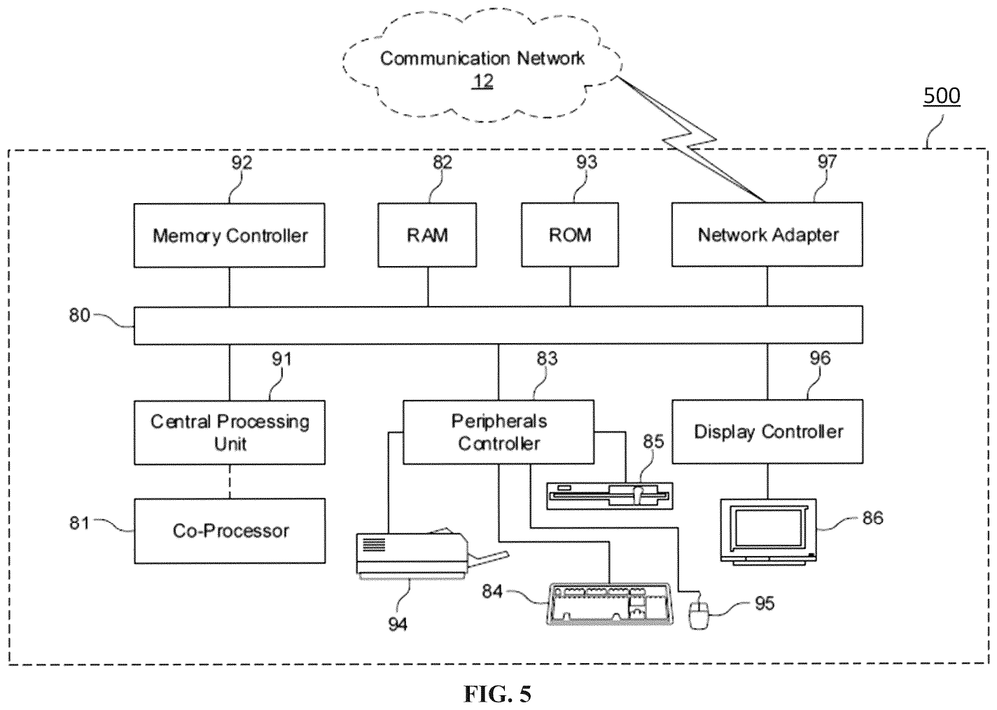

FIG. 5 is a block diagram of an exemplary computing system 500. In some exemplary embodiments, the network device 160 may be a computing system 500. The computing system 500 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 500 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 500 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 500 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 500. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 500 may contain communication circuitry, such as for example a network adaptor 97, that may be used to connect computing system 500 to an external communications network, such as network 12 of FIG. 4, to enable the computing system 500 to communicate with other nodes (e.g., UE 30) of the network.

### Exemplary System Operation

Some examples of the present disclosure may relate to triggering of actions based on text captured in a field of view of smart glasses and/or augmented/virtual reality devices. In this regard, examples of the present disclosure may enable smart glasses and/or augmented/virtual reality devices to facilitate capture of one or images and/or one or more videos associated with a field of view of a real world environment. The smart glasses and/or augmented/virtual reality devices may analyze one or more text items in captured images and/or videos to determine interesting text. The determined interesting text may be utilized by the smart glasses and/or augmented/virtual reality devices to initiate/trigger one or more actions or functions performed by the smart glasses and/or augmented/virtual reality devices.

The ability to easily take action on text in the world may enable users of smart glasses and/or augmented/virtual reality devices to be more efficient in daily activities and may enhance user interaction. Enhancing productivity with text actions in the realm of real world content may be beneficial for users of smart glasses and/or augmented/virtual reality devices.

In some examples, the HMD 210 of the artificial reality system 200 may be configured to analyze and/or read text from pixels, captured in images/videos, to convert into digital characters. In this regard, the HMD 210 may utilize optical character recognition (OCR) detection and/or recognition models to determine digital characters (e.g., letters and/or characters associated with words and/or alphanumeric characters) associated with text of a captured image(s) and/or video(s). The captured image(s) and/or video(s) may be captured by a camera (e.g., front camera 216, rear camera 218) of the artificial reality system 200.

The HMD 210 of the examples of the present disclosure may determine which text items among the captured text in an image(s)/video(s) is interesting text and may facilitate one or more actions on the determined interesting text.

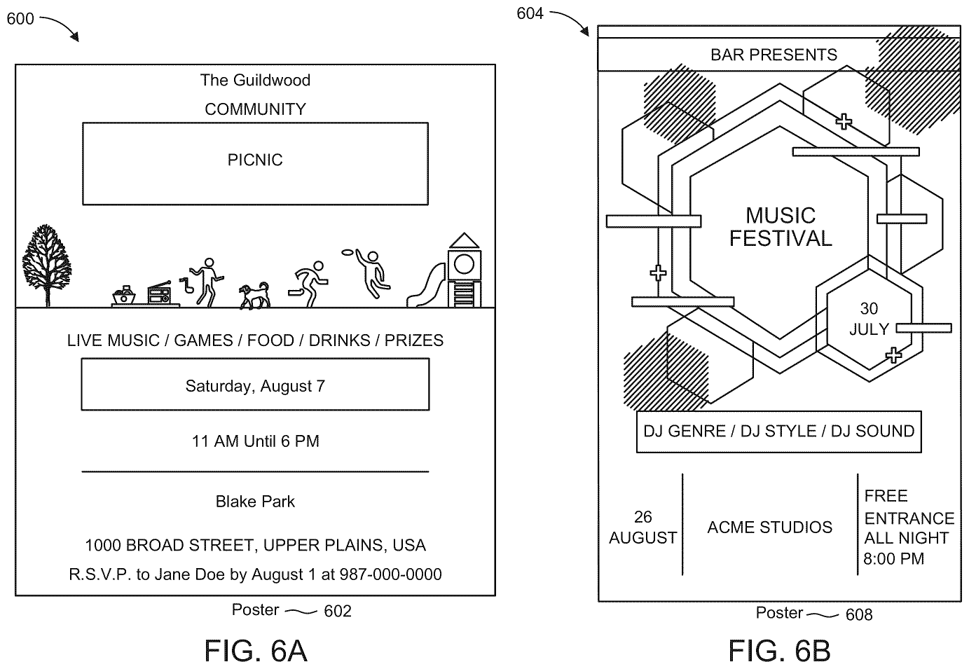

The HMD 210 may determine a type of object(s) associated with captured text, a place/location associated with the captured text and/or a meaning(s)/understanding associated with the captured text. For example, by utilizing machine learning models trained on training data regarding various types of objects and categories of objects, the HMD 210 may determine types of objects associated with the text being captured from images and/or videos. Some examples of the types of objects may include for purposes of illustration and not of limitation, posters, billboards, menus, packaged goods, books and any other suitable objects. For example, in FIG. 6A and FIG. 6B, the HMD 210 may determine that a first captured image 600 includes a type of object such as a poster 602 and that a second captured image 604 includes a type of object such as, for example, a poster 608, respectively.

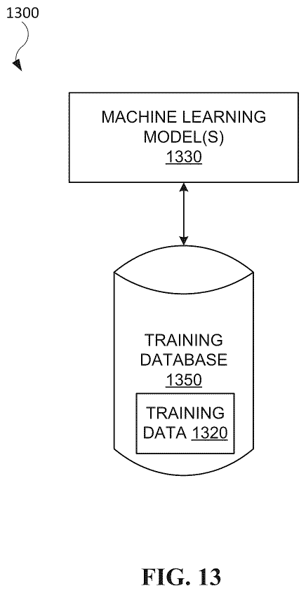

Additionally, the HMD 210 may analyze a captured image(s) and/or video(s) to determine the place that a user wearing the HMD 210 is in or is located. In this regard, the HMD 210 may determine the place and/or location associated with the captured image(s) and/or video(s) based on GPS and/or determined visual signals. For instance, the HMD 210 may include a GPS device (e.g., GPS chipset 50), which may determine a current location (e.g., based on longitude and latitude coordinates) of the HMD 210 and/or the location of the HMD 210 in an instance in which the image(s) and/or video(s) was taken/captured. In some examples, the HMD 210 may implement machine learning models (e.g., machine learning model(s) 1330 of FIG. 13) trained on training data associated with images corresponding to places to determine a place/location associated with captured text.

For instance, the HMD 210 may implement machine learning models trained on data (e.g., imaging data) regarding which different entities associated with the captured text may appear similar to for example venues such as restaurants, sports facilities (e.g., sports arenas, baseball fields, basketball courts, etc.), concert venues, and any other suitable venues. In this regard, the machine learning models associated with imaging pertaining to places/locations may be associated with predetermined categories of classes of images (e.g., 1,000 categories, etc.) and the HMD 210 may utilize the captured image(s)/video(s) that is also associated with captured text to determine which category a place/location associated with the captured image(s)/video(s) looks most similar to in relation to images/videos associated with the one or more machine learning models. In some examples, the machine learning models may adapt and be refined in real-time. For instance, as the machine learning models encounter more locations and/or places based on captured images/videos (e.g., captured by an HMD(s) 210), the machine learning models may learn more locations and/or places to add to the machine learning training data and thus may add new locations and/or places to the machine learning models. As such, the accuracy of locations and/or places determined by the machine learning models may be enhanced.

Some examples of the categories of objects may include, but are not limited to, organizing media objects (e.g., receipts, signs, sticky notes, whiteboards, etc.), grocery and consumable objects (e.g., fruit, canned food goods, etc.), home and outdoor objects (e.g., sofas, stoves, cars, etc.), smart home devices objects (e.g., televisions, speakers, vacuums, floor lamps, etc.) and any other suitable category of objects. These categories of objects may be trained based on training data (e.g., training data 1320 of FIG. 13) of one or more machine learning models (e.g., machine learning model(s) 1330 of FIG. 13).

Additionally, the HMD 210 may determine specific items about the captured text to understand the text itself (e.g., semantic intent associated with the text). For example, HMD 210 may understand/determine the meaning of the text based in part on the machine learning models. For instance, the machine learning models (e.g., machine learning model(s) 1330) may be trained with predetermined content designating items of text content as interesting. For example, detected captured text may be designated as interesting based on the predetermined content designating items of text content associated with the machine learning models as interesting, including but not limited to, names, phone numbers, contacts, dates, events, venues, websites, menu items, text in another language, etc. In some other examples, any other suitable text content may be designated as interesting text based on being trained as interesting text content by the machine learning models (e.g., machine learning model(s) 1330). Additionally, in other examples, detected captured text may be designated as interesting by the HMD 210 based on the surrounding object(s) and scene being captured (e.g., by the HMD 210). For purposes of illustration and not of limitation, as an example, if the user of the HMD 210 is at a grocery store and holds up a milk carton in the field of view of the HMD 210, the label of the milk carton may be more interesting compared to random text that the HMD 210 may detect in the background, for instance, in the aisle of the grocery store.

For purposes of illustration and not of limitation, the HMD 210 may implement the machine learning models (e.g., machine learning model(s) 1330) and may determine whether captured text (e.g., from a captured image/video) is associated with a name of a menu item, a phone number, an address, an email address, a website, a contact(s), a language associated with the captured text in relation to a language setting associated with the artificial reality system 200, and may then determine whether to translate the captured text. In this regard, the HMD 210 of the examples of the present disclosure may determine contextual signals (e.g., corresponding to the machine learning models) associated with the captured text to determine higher-level semantics of intent associated with the captured text. Continuing with the above milk carton example, the HMD 210 may determine higher-level semantics of intent associated with the captured text, of the label of the milk carton, such as for example the user “wants to buy milk.” As another example, for purposes of illustration and not of limitation, in an instance in which the HMD 210 detects that captured text indicates a phone number, the HMD 210 may determine higher-level semantics of intent such as, for example, “call this phone number” which is associated with the captured text of the phone number. The higher-level semantics of intent, for example, may denote that a user(s) of the HMD 210 may be interested in the captured text.

In some examples, in an instance in which the HMD 210, based on implementing the one or more machine learning models, may not determine any interesting text (e.g., the predetermined content designating items of text content as interesting is not determined) associated with a captured image(s)/video(s), the HMD 210 may perform an action such as generating a prompt to present to the user (e.g., via the display 214) asking/inquiring the user whether the user wants to save all of the captured text in the captured image/video to a memory device (e.g., non-removable memory 44). In this example, the user may interface with the prompt via a display (e.g., display 214) and may select an option to save all the captured text to the memory device or to delete the captured text.

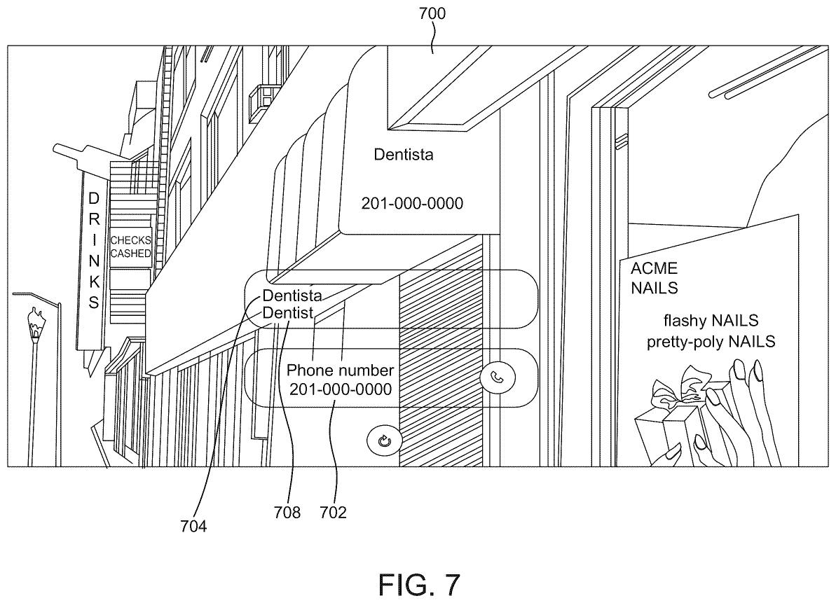

For purposes of illustration and not of limitation, consider an instance in which a user of an HMD 210 presses one of the buttons 302 and/or the user performs a hand movement or finger movement or the like corresponding to a predetermined hand gesture or predetermined finger gesture to cause/trigger the HMD 210 to capture an image(s)/video(s) including text corresponding to a real world environment in a field of view of a camera (e.g., front camera 216) of the HMD 210. For example, consider FIG. 7, in which the HMD 210 captured image 700 and determined that the image 700 includes text determined by the HMD 210 as interesting text, based on implementing the one or more machine learning models. In this example, the determined interesting text may be a phone number 702 and a name 704 of an entity in the Spanish language such as dentista. The HMD 210 may determine the text associated with the image 700 by utilizing/implementing OCR detection of the scene of the real world environment associated with the image 700. In this example, in response to determining the interesting text from the image 700, the HMD 210 may trigger/initiate one or more actions to be performed by the HMD 210. For example, the HMD 210 may cause a communication/navigation panel to be presented via a display (e.g., display 214) for the detected phone number 702 in which the user may navigate (e.g., by selecting one or more buttons 302) through the communication/navigation panel to select the phone number 702 to initial a telephone call associated with the phone number 702.

As another example, in response to determining the interesting text from the image 700, the HMD 210 may trigger/initiate an action(s) such as generating a prompt to the communication/navigation panel presenting (e.g., via display 214) the user of the HMD 210 with an option to copy the detected text (e.g., text associated with the phone number 702, text associated with the name 704 of the entity in Spanish i.e., dentista). In some examples, the copied text may be copied to a clipboard and/or to a memory device. The HMD 210 may also present (e.g., via the display 214) the user of the HMD 210 an option to paste the detected copied text. For example, the detected copied text may be pasted into a communication (e.g., a message), saved to a memory device (e.g., non-removable memory 44) of the HMD 210 and/or input into an application (app) associated with the HMD 210.

In some examples, the options to perform actions on the text determined as interesting may be automatically performed by the HMD 210 and presented, via a display and/or user interface to the user for the user to choose. The user of the HMD 210 may select a preselected option for the HMD 210 to automatically determine captured text as being interesting. In this regard, the preselected option may enable the HMD 210 to automatically determine interesting text based on the user's (of the HMD 210) prior history of determined interesting text. In another example, in an instance in which the captured text may not have a determined score (e.g., determined by the HMD 210) above a predetermined threshold confidence level (e.g., 80%, 85%, 90%, etc.) as being interesting, the HMD 210 may present, via a display and/or user interface to the user a list of options of candidate interesting text for the user to choose (e.g., via the user interface) as interesting text.

Additionally, in the example of FIG. 7, consider that the HMD 210 generated a prompt to the communication/navigation panel presenting (e.g., via the display 214) the user of the HMD device 210 an option to see/view the translation of the name 704 of the text in the view of the image 700 in a language associated with the HMD 210 such as for example English. In this regard, consider that the user selected the option (e.g., by using one or more buttons 302 to navigate the panel via the display 214) to see/view the translation of the name 704 of the text in the language associated with the HMD 210. As such, the HMD 210 may translate the name 704 i.e., dentista in Spanish to English text dentist 708.

As another example, consider for example an instance in which the captured image 700 included a website as text captured in the image 700. In this regard, for example, the HMD 210 may generate a prompt to the communication/navigation panel presenting (e.g., via the display 214) the user of the HMD device 210 an option to open a link (e.g., a uniform resource locator (URL)) associated with the website. As another example, if the image 700 included a captured Quick Response (QR) code and/or a social media handle, the HMD 210 may generate a prompt to the communication/navigation panel presenting (e.g., via the display 214) the user of the HMD device 210 an option to open a link (e.g., URL) associated with the QR code and/or the social media handle.

In some other examples, the HMD 210 may generate a prompt to the communication/navigation panel presenting (e.g., via the display 214) the user of the HMD device 210 an option to translate determined interesting text (e.g., phone number 602) to audio such that the determined interested text may be output and heard by the user as audio playback (e.g., by the audio device 206).

Additionally, in some other examples, the HMD 210 may generate a prompt to the communication/navigation panel presenting (e.g., via the display 214) the user of the HMD device 210 an option to look up places such as, for example, determining more information about a place (e.g., the dentist office associated with name 708) or similar interesting places (e.g., other dentist offices in a same city as the dentist office associated with name 708). In this example, in response to the user selecting the option to look up places, the HMD 210 may present (e.g., via display 214) the user with additional dentist offices in the same city.

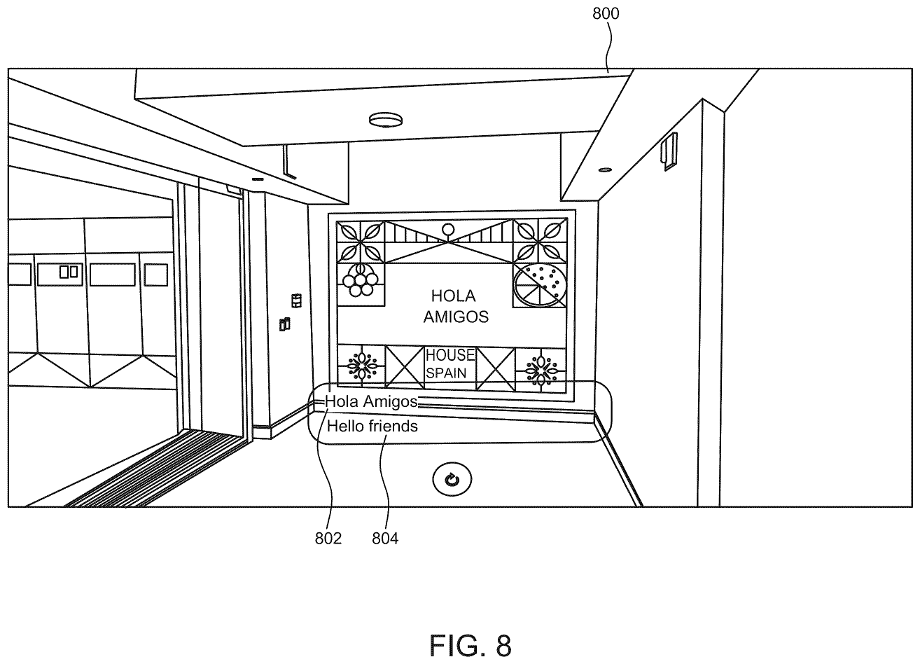

As another example in FIG. 8, the HMD 210 may capture an image 800 of a scene and may determine interesting text such as, for example, Hola Amigos 802. In this example, Hola Amigos 802 may be designated by the HMD 210 as interesting text because Hola Amigos 802 is in a language (e.g., Spanish) that the user of the HMD 210 does not understand. In this regard, the HMD 210 may generate a prompt provided to a communication/navigation panel that a user of the HMD 210 may utilize to select (e.g., by using one or more buttons 302 of the EMG devices 300) whether to translate the interested text such as Hola Amigos 802 to a translated interested text, i.e., Hello Friends 804, in a language (e.g., English) designated or associated with a setting of the HMD 210. In this example, consider that the user selected to translate the interesting text Hola Amigos 802 to Hello Friends 804 in the language (e.g., English) associated with the setting, or designated as the default language, of the HMD 210.

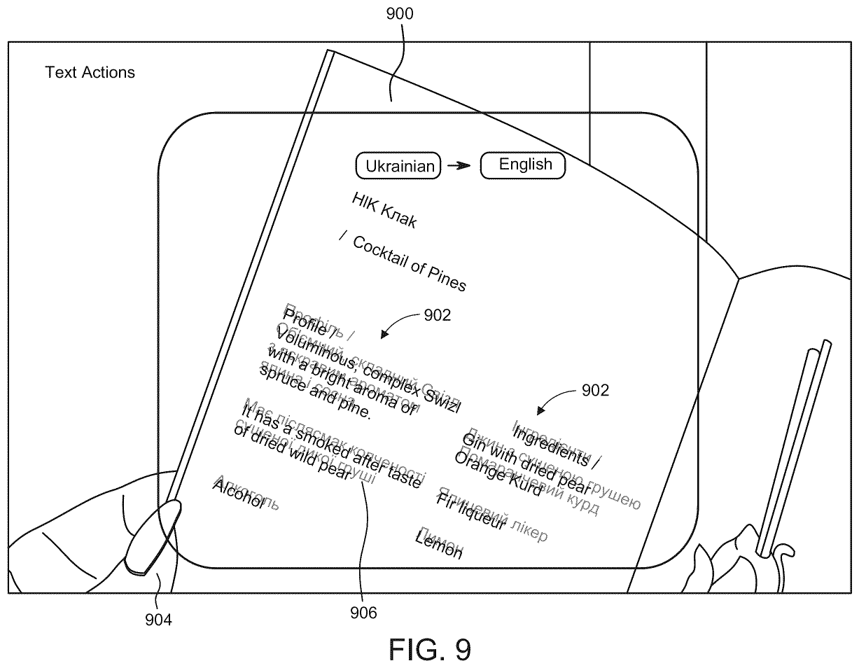

Referring now to FIG. 9, a diagram illustrating translated text based on text captured in a field of view of an HMD being presented superimposed over text of a real-world environment is provided in accordance with an example of the present disclosure. In the example of FIG. 9, a camera of the HMD 210 may capture an image of a menu in a field of view of the camera in response to selection or depression of one of the buttons 302 of the EMG devices 300 and/or in response to a gesture movement being performed by the user of the HMD 210 in which the HMD 210 may determine that the gesture movement by the user corresponds to a predetermined gesture movement (e.g., hand gesture, finger gesture, etc.) to trigger capture of an image in the field of view of the camera. In the example of FIG. 9, in an instance in which the user may be utilizing the HMD 210 to view a real-world environment of a menu (e.g., menu 900) captured in the field of view of a camera (e.g., front camera 216, camera 54) of the HMD 210, the HMD 210 may determine that the menu 900 is in another language other than the default language of the HMD 210, which may be designated by the HMD 210 and/or by the user. In this example, the HMD 210 may determine that the menu 900 is in a language such as, for example, Ukrainian and that the default language of the HMD 210 is in English. As such, the HMD 210 may translate content 902 (e.g., menu items) on the menu 900 into the English language. The HMD 210 may cause/trigger the field of view of the camera of the HMD 210 to show the user the translated content 902 (e.g., menu items translated to the English language) superimposed over corresponding real-world text (e.g., menu items in the Ukrainian language) associated with the menu 900.

In some other examples, in view of a limited space of a display (e.g., display 214) on an HMD and in view of limited space for user interactions, an HMD may need to understand the user intent associated with captured text. As such, in the example of FIG. 9, the position of a finger 904 on, or associated with, a menu item(s) may be determined by the HMD 210 as a representation of the user intent to translate the text, in real time, associated with the menu item(s) being pointed at, or hovered over, for example. In this regard, for example, the user of the HMD 210 may utilize the position of their finger to specify the text that the user may like to be translated from the language (e.g., Ukrainian) of the menu item(s) of the menu 900 to another language such as, for example, a language (e.g., English) designated as the default language of the HMD 210.

In the example of FIG. 9, a user may point a finger 904 at a menu item 906 while the finger 904 and the menu 900 are in the field of view of a camera (e.g., front camera 216, camera 54) of the HMD 210. In response to the HMD 210 detecting the position of the finger 904 pointed at, or associated with, the menu item 906, the HMD 210 may translate, in real time (e.g., live), the menu item 906 to another language (e.g., English), which may be presented/displayed (e.g., via display 214) by the HMD 210 to the user as translated text such as “It has a smoked after taste of dried wild pear” in this example. The translated text such as “It has a smoked after taste of dried wild pear” associated with menu item 906 may be superimposed over the text associated with the menu item 906. Although FIG. 9 illustrates an example in which the HMD 210 may translate content from a menu and superimpose corresponding translated text in another language over the content in a different language captured from the menu, it should be pointed out that the object(s) need not be a menu and may be any other suitable object(s) from which content may be translated (e.g., instructions on a document, a sign, a poster, a billboard, etc.).

In some other examples, the HMD 210 may generate a prompt to a communication/navigation panel presenting (e.g., via the display 214) the user of the HMD device 210 an option to look up things such as, for example, determining more information about a menu item, a food item(s) (e.g., calories), a restaurant(s) or other item(s) and/or product. For instance, in this example, in response to the user selecting the option to look up things, the HMD 210 may present (e.g., via display 214) the user with additional information regarding the menu item(s) 904 and or a restaurant associated with the menu 900 or other similar restaurants (e.g., within a same city, etc.). In some other examples, the option to look up things may enable the HMD 210 to determine additional information about other items captured in an image or video, including but not limited to products (e.g., product ratings), pets (e.g., dog breeds), plants (e.g., plant care instructions), and/or information about any other suitable items.

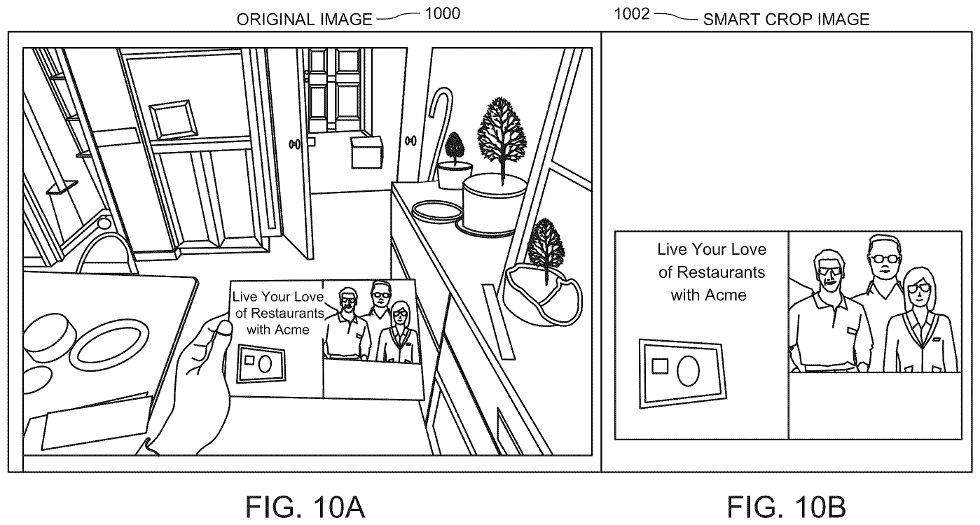

Referring to FIG. 10A and FIG. 10B, diagrams illustrating smart crop features in accordance with examples of the present disclosure are provided. The smart crop features may enable defining of a region of interest (ROI) from an original captured image(s) and/or video(s) for downstream processing on the original captured image(s)/video(s) by a device (e.g., HMD 210) to determine textual content of interest to a user. The textual content may be identified based on OCR detection performed on the captured image(s)/video(s) and may be generated as a smart crop image(s)/video(s).

Text in real world environments is ubiquitous. However, not all text may be desirable for consumption by a user. Moreover, processing of undesirable and/or superfluous text captured from images and/or video(s) associated with real world environments may undesirably constrain communication device resources such as, for example, memory, power and/or latency associated with smart glasses.

An HMD may capture a large field of view of a scene associated with a real world environment. From the standpoint of OCR detection, this may denote that the HMD may capture a large amount of background detail/data which may include irrelevant text or one or more irrelevant background regions. In this regard, the smart crop features of examples of the present disclosure may be implemented by the HMD (e.g., HMD 210) and may determine/provide an estimation of textual intent of interest to a user.

For instance, in FIG. 10A, the captured/original image 1000 shows a document (e.g., a flyer) held in a hand of a user. The HMD 210 may implement the smart crop features by analyzing the original image 1000 of FIG. 10A and may determine that since the user is holding the document in a hand, the user wants to read text from the document. As such, the HMD 210 may implement the smart crop features on the captured/original image 1000 of FIG. 10A and may determine that a corresponding smart crop image should just include the region associated with the document (also referred to herein as document region), in which the HMD 210 may illustrate the smart crop image 1002 in FIG. 10B. In this manner, the HMD 210 may implement the smart crop features to remove irrelevant/superfluous background regions and/or irrelevant/superfluous data from the original image 1000.

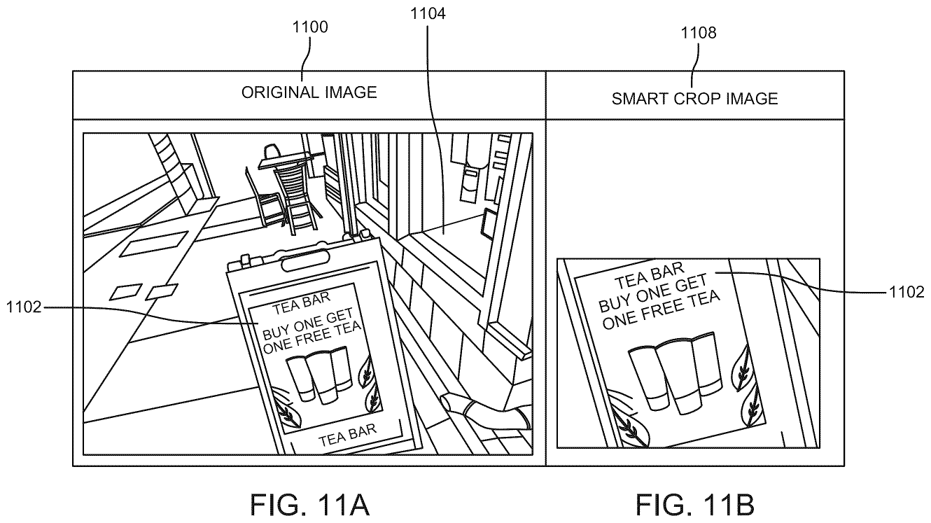

Referring to FIG. 11A and FIG. 11B, diagrams illustrating smart crop features in accordance with other examples of the present disclosure are provided. In the example of FIG. 11A, the captured original image 1100 may illustrate an image of a poster board 1102 along with some background text on a glass wall 1104 and other items associated with the scene of the real world environment of the original image 1100. In this example, the HMD 210 may implement the smart crop features on the original image 1100 and may determine that the smart crop features provides/generates the region of interest around the poster board 1102 shown in the smart crop image 1108 of FIG. 11B. In this regard, in generating the smart crop image 1108, the HMD 210 may exclude the background text on the glass wall 1104 and one or more of the other items associated with the scene of the original image 1100.

The examples of the present disclosure may enable the HMD 210 to implement two approaches to determine a smart crop region(s). The first approach may be for the HMD 210 to implement/utilize a hand object interaction (HOI) model. By utilizing the HOI model (as in smart crop image 1002 of FIG. 10B), the HMD 210 may determine that if a user in the captured image has a hand holding a textual object, then the user's intent is clear in that the user is interested in the textual object. In this regard, the HOI model may be utilized/implemented by the HMD 210 to detect the object in the hand and may utilize this detected object (e.g., the textual object (e.g., the document)) in the hand as the smart crop image (e.g., smart crop image 1002).

The second approach may be for the HMD 210 to implement/utilize a word detector box(es) to estimate/determine a smart crop region and thus a smart crop image. In this second approach, the HMD 210 may utilize one or more word detector boxes and may determine a smart crop center of an image (e.g., original image 1100) that may maximize all the word bounding boxes together. The one or more word detector boxes may identify all the sections of an image in which the word detector boxes determines words exist (e.g., as a first pass approach). Based on the locations in which the words exist, the one or more word detector boxes may crop an image smartly to eliminate the sections of the image that have no words, and instead focus on the resulting image where the detected words exist (e.g., where the word bounding boxes are mostly clustered). The reason for doing this is because other approaches such as utilizing optical character recognition (OCR) as a first pass on the image may take the image and fit the image into a fixed resolution. However, doing so at the full image level may be suboptimal as it may compress the words to a smaller size, thus negatively impacting readability by a machine (e.g., this may particularly be the case for images with a lot of non-word regions). By utilizing the one or more word detector boxes, aspects of the present disclosure may utilize a smartly cropped image(s) (e.g., a resulting image having the detected words), and thus maximize the size of the words, and the readability of the words.

For example, the HMD 210 may run/implement a word box detector on the captured original image (e.g., original image 1100). The HMD 210 may then determine a smart crop center by taking a mean (e.g., an average) of one or more word bounding boxes to identify where most of the text is clustered. The HMD 210 may thereafter utilize a fixed size crop window (1080×810 pixels as an example) around the smart crop center to select the smart crop from the original image. The HMD 201 may subsequently run/implement a second pass word box detector and recognition to enable determining a new set of word boxes and corresponding words. The second pass word box detector may involve a technique that occurs after/in response to the word detector box(es) operation described above. The second pass word box detector may utilize the smartly cropped image and run/implement OCR (e.g., as a second pass) to actually read the words of the smartly cropped image. The first pass, described above, may be a type of word detection to approximately determine which sections of an image have words in the image. In some instances, the readability/accuracy of the word recognition may need improvement (e.g., if the image includes a lot of non-word regions). After identifying the sections of the image that have words and cropping around the words, the second pass approach of the second pass word box detector may perform OCR detection/recognition to provide higher accuracy results on what the words actually say in the smartly cropped image.

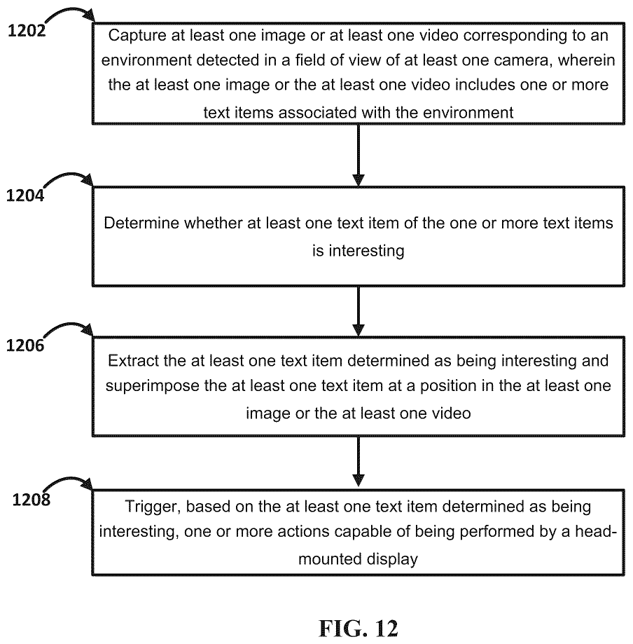

FIG. 12 illustrates an example flowchart illustrating operations for determining interesting text to trigger actions of devices according to an example of the present disclosure. At operation 1202, a device (e.g., HMD 210) may capture at least one image or at least one video corresponding to an environment detected in a field of view of at least one camera. The at least one image or the at least one video may include one or more text items associated with the environment (e.g., a real world environment). In some examples, the device may determine the one or more text items by performing optical character recognition detection on the text being captured, by a camera (e.g., front camera 216, camera 54), in the image(s) and/or the video(s) for example in real-time. Additionally, in some examples the device may be smart glasses or an augmented or virtual reality device. At operation 1204, a device (e.g., HMD 210) may determine whether at least one text item of the one or more text items is interesting. A text item(s) being interesting may denote that the text item(s) is interesting to a user of the device (e.g., HMD 210).

The determining by the device regarding whether a text item(s) is interesting may include determining, by the device, that the at least one text item corresponds to at least one predetermined content item of text content designated as interesting associated with training data (e.g., training data 1320 of FIG. 13) of one or more machine learning models (e.g., machine learning model(s) 1330 of FIG. 13).

In another example, the determining by the device that the at least one text item is interesting may be in response to determining, based on the at least one image or the at least one video, that at least one hand of a user holds, or points to, an object associated with the at least one text item. In some other examples, the device may crop out one or more regions or other text items captured in the at least one image (e.g., original image 1000) or the at least one video in response to determining that the hand of the user holds, or points to, the object associated with the at least one text item to obtain a second image (e.g., smart crop image 1002) or a second video including the at least one text item and excluding the one or more regions or the other text items.

Additionally or alternatively, in some examples the device may determine, based on analyzing the at least one image (e.g., original image 1100) or the at least one video, at least one region of interest associated with the at least one text item determined as being interesting and one or more background items or other items associated with a scene of the environment (e.g., real world environment). In this regard, the device may crop out the one or more background items or the other items to obtain a second image (e.g., smart crop image 1108) or a second video including the at least one region of interest and the at least one text item.

At operation 1206, a device (e.g., HMD 210) may extract the at least one text item determined as being interesting and may superimpose the at least one text item at a position in the at least one image or the at least one video. At operation 1208, a device (e.g., HMD 210) may trigger, based on the at least one text item determined as being interesting, one or more actions capable of being performed by the device (e.g., HMD 210). In some examples, at least one action of the one or more actions may include translating the at least one text item in a first language (e.g., Spanish) to a translated text item in a second language (e.g., English) associated with the device (e.g., HMD 210).

In some other examples, the device may perform the translating of the at least one text item in the first language to the translated text item in the second language in response to detecting at least one finger of a user, associated with the device, pointing at or hovering over the at least one text item in the environment. The device (e.g., HMD 210) may present the translated text item in the second language superimposed within the at least one image or the at least one video. The device may generate a prompt (e.g., via a communication/navigation panel) associated with a display (e.g., display 214) of the device enabling a user associated with the device to select at least one action(s) of the one or more actions to enable the device to perform the at least one action(s). The at least one action(s) may relate to the device copying the text item determined as being interesting, pasting the text item determined as being interesting, extracting a phone number(s), a website(s), an email address(es), a contact(s)/contact list(s) associated with the text item determined as being interested from the captured image(s) and/or captured video(s). In other examples, the at least one action(s) may relate to the device performing any other suitable actions.

FIG. 13 illustrates an example of a machine learning framework 1300 including machine learning model(s) 1330 and a training database 1350, in accordance with one or more examples of the present disclosure. The training database 1350 may store training data 1320. In some examples, the machine learning framework 1300 may be hosted locally in a computing device or hosted remotely. By utilizing the training data 1320 of the training database 1350, the machine learning framework 1300 may train the machine learning model(s) 1330 to perform one or more functions, described herein, of the machine learning model(s) 1330. In some examples, the machine learning model(s) 1330 may be stored in a computing device. For example, the machine learning model(s) 1330 may be embodied within an HMD (e.g., HMD 210). In some other examples, the machine learning model(s) 1330 may be embodied within another device (e.g., computing system 500). Additionally, the machine learning model(s) 1330 may be processed by one or more processors (e.g., controller 204 of FIG. 2, coprocessor 81 of FIG. 5). In some examples, the machine learning model(s) 1330 may be associated with operations (or performing operations) of FIG. 12. In some other examples, the machine learning model(s) 1330 may be associated with other operations.

In an example, the training data 1320 may include attributes of thousands of objects. For example, the objects may be posters, brochures, billboards, menus, goods (e.g., packaged goods), books, groceries, QR codes, smart home devices, home and outdoor items, household objects (e.g., furniture, kitchen appliances, etc.) and any other suitable objects. In some other examples, the objects may be smart devices (e.g., HMDs 210, communication devices 105, 110, 115, 120), persons (e.g., users), newspapers, articles, flyers, pamphlets, signs, cars, content items (e.g., messages, notifications, images, videos, audio), and/or the like. Attributes may include, but are not limited to, the size, shape, orientation, position/location of the object(s), etc. The training data 1320 employed by the machine learning model(s) 1330 may be fixed or updated periodically. Alternatively, the training data 1320 may be updated in real-time based upon the evaluations performed by the machine learning model(s) 1330 in a non-training mode. This may be illustrated by the double-sided arrow connecting the machine learning model(s) 1330 and stored training data 1320. Some other examples of the training data 1320 may include, but are not limited to, predetermined content designating items of text content as interesting. For example, detected captured text may be determined/designated as interesting based on the predetermined content designating items of text content associated with the machine learning model(s) 1330 as being interesting, including but not limited to, names, phone numbers, contacts, dates, events, venues, websites, QR codes, menu items, text in another language, etc. In some other examples, any other suitable text content may be designated as interesting text based on being trained with the training data 1320 as interesting text content by the machine learning model(s) 1330.

A device (e.g., HMD 210) may implement the machine learning model(s) 1330 and may determine whether captured text (e.g., from a captured image/video) is associated with a name of an entity, a name of a menu item(s), a phone number(s), an address(es), an email address(es), a website(s), a contact(s), a language(s) associated with the captured text in relation to a language setting, or a language designation, associated with a device, and the device may then determine whether to translate the captured text to another language.

Additionally, the machine learning model(s) 1330 may be trained on training data 1320 (e.g., imaging/video data) regarding what different entities associated with the captured text may appear similar to, for example, venues such as restaurants, sports facilities (e.g., sports arenas, baseball fields, basketball courts, etc.), concert venues, and any other suitable venues. The machine learning model(s) 1330 associated with training data 1320 including imaging/video data pertaining to places/locations may be associated with predetermined categories of classes of images (e.g., 1,000 categories, etc.). A device (e.g., HMD 210) may utilize the captured image(s)/video(s) that is also associated with captured text to determine which category (e.g., a restaurant, etc.) the place/location in the captured image(s)/video(s) looks most similar to in relation to images/videos of the training data 1320 associated with the machine learning model(s) 1330. In some examples, the machine learning model(s) 1330 may adapt and may be refined in real-time and the accuracy of the predictions of the machine learning model(s) 1330 may improve over time.

### ALTERNATIVE EMBODIMENTS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
capturing, via a head mounted device, at least one image or at least one video corresponding to an environment detected in a field of view of at least one camera, wherein the at least one image or the at least one video comprises one or more text items associated with the environment;
determining whether at least one text item of the one or more text items is interesting;
extracting the at least one text item determined as being interesting and superimposing the at least one text item at a position in the at least one image or the at least one video; and
triggering, based on the at least one text item determined as being interesting, one or more actions capable of being performed by the head mounted device.

2. The method of claim 1, wherein the head mounted device comprises smart glasses or an augmented or virtual reality device.

3. The method of claim 1, further comprising:
the determining whether the at least one text item of the one or more text items is interesting comprises determining that the at least one text item corresponds to at least one predetermined content item of text content designated as interesting associated with training data of one or more machine learning models.

4. The method of claim 1, further comprising:
determining that the at least one text item is interesting in response to determining, based on the at least one image or the at least one video, that at least one hand of a user holds, or points to, an object associated with the at least one text item.

5. The method of claim 4, further comprising:
cropping out one or more regions or other text items captured in the at least one image or the at least one video in response to determining the at least one hand of the user holds, or points to, the object associated with the at least one text item to obtain a second image or a second video comprising the at least one text item and excluding the one or more regions or the other text items.

6. The method of claim 1, further comprising:
determining, based on analyzing the at least one image or the at least one video, at least one region of interest associated with the at least one text item determined as being interesting and one or more background items or other items associated with a scene of the environment; and
cropping out the one or more background items or the other items to obtain a second image or a second video comprising the at least one region of interest and the at least one text item.

7. The method of claim 1, wherein at least one action of the one or more actions comprises translating the at least one text item in a first language to a translated text item in a second language associated with the head mounted device.

8. The method of claim 7, further comprising:
performing the translating the at least one text item in the first language to the translated text item in the second language in response to detecting at least one finger of a user, associated with the head mounted device, pointing at or hovering over the at least one text item in the environment.

9. The method of claim 7, further comprising:
presenting, by the head mounted device, the translated text item in the second language superimposed within the at least one image or the at least one video.

10. The method of claim 1, further comprising:
generating a prompt, by the head mounted device, enabling a user associated with the head mounted device to select at least one action of the one or more actions to enable the head mounted device to perform the at least one action.

11. An apparatus comprising:
one or more processors; and
at least one memory storing instructions, that when executed by the one or more processors, cause the apparatus to:
capture, via the apparatus, at least one image or at least one video corresponding to an environment detected in a field of view of at least one camera, wherein the at least one image or the at least one video comprises one or more text items associated with the environment;
determine whether at least one text item of the one or more text items is interesting;
extract the at least one text item determined as being interesting and superimposing the at least one text item at a position in the at least one image or the at least one video; and
trigger, based on the at least one text item determined as being interesting, one or more actions capable of being performed by the apparatus.

12. The apparatus of claim 11, wherein the apparatus comprises a head mounted device, smart glasses or an augmented or virtual reality device.

13. The apparatus of claim 11, wherein when the one or more processors further execute the instructions, the apparatus is configured to:
perform the determine whether the at least one text item of the one or more text items is interesting by determining that the at least one text item corresponds to at least one predetermined content item of text content designated as interesting associated with training data of one or more machine learning models.

14. The apparatus of claim 11, wherein when the one or more processors further execute the instructions, the apparatus is configured to:
determine that the at least one text item is interesting in response to determining, based on the at least one image or the at least one video, that at least one hand of a user holds, or points to, an object associated with the at least one text item.

15. The apparatus of claim 14, wherein when the one or more processors further execute the instructions, the apparatus is configured to:
crop out one or more regions or other text items captured in the at least one image or the at least one video in response to determining the at least one hand of the user holds, or points to, the object associated with the at least one text item to obtain a second image or a second video comprising the at least one text item and excluding the one or more regions or the other text items.

16. The apparatus of claim 11, wherein when the one or more processors further execute the instructions, the apparatus is configured to:
determine, based on analyzing the at least one image or the at least one video, at least one region of interest associated with the at least one text item determined as being interesting and one or more background items or other items associated with a scene of the environment; and
crop out the one or more background items or the other items to obtain a second image or a second video comprising the at least one region of interest and the at least one text item.

17. The apparatus of claim 11, wherein at least one action of the one or more actions comprises translating the at least one text item in a first language to a translated text item in a second language associated with the apparatus.

18. The apparatus of claim 17, wherein when the one or more processors further execute the instructions, the apparatus is configured to:
perform the translating the at least one text item in the first language to the translated text item in the second language in response to detecting at least one finger of a user, associated with the apparatus, pointing at or hovering over the at least one text item in the environment.

19. A non-transitory computer-readable medium storing instructions that, when executed, cause:
capturing, via a head mounted device, at least one image or at least one video corresponding to an environment detected in a field of view of at least one camera, wherein the at least one image or the at least one video comprises one or more text items associated with the environment;
determining whether at least one text item of the one or more text items is interesting;
extracting the at least one text item determined as being interesting and superimposing the at least one text item at a position in the at least one image or the at least one video; and
triggering, based on the at least one text item determined as being interesting, one or more actions capable of being performed by the head mounted device.

20. The computer-readable medium of claim 19, wherein the instructions, when executed, further cause:
the determining whether the at least one text item of the one or more text items is interesting comprises determining that the at least one text item corresponds to at least one predetermined content item of text content designated as interesting associated with training data of one or more machine learning models.
